(19) United States
(12) Patent Application Publication
(10) Pub. No.: US 2018/0064156 A1
(43) Pub. Date: Mar. 8, 2018

(54) RED GINSENG EXTRACT GRANULES, AND METHOD FOR PREPARING RED GINSENG EXTRACT GRANULES USING RED GINSENG EXTRACT POWDER AND FLUIDIZED-BED COATER

(71) Applicant: HONGSAMDAN CO., LTD., Daejeon (KR)

(72) Inventors: Myunggon SHIN, Daejeon (KR); Dongsuk SHIN, Daejeon (KR); Soonho KWON, Daejeon (KR); Sungbum PARK, Daejeon (KR)

(73) Assignee: HONGSAMDAN CO., LTD., Daejeon (KR)

(21) Appl. No.: 15/124,652

(22) PCT Filed: Feb. 3, 2016
(86) PCT No.: PCT/KR2016/001176

§ 371 Date: Sep. 8, 2016

(30) Foreign Application Priority Data
Jan. 29, 2016 (KR) 10-2016-0011729

(51) Int. Cl. A23P 10/22; A23P 20/10

(52) U.S. Cl. CPC A23P 10/22; A23P 20/10; A23V 2300/38; A23V 2250/2124; A23V 2300/14; A23V 2002/00

(57) ABSTRACT

The present invention relates to red ginseng extract granules, and a method for preparing the red ginseng extract granules using red ginseng extract powder and fluidized-bed coater, in that a red ginseng extract is dried through a vacuum drier; a red ginseng extract powder of a predetermined size is prepared via a roll mill grinding process; it prepares 100% pure red ginseng extract granules having particle sizes of 1.2 to 1.7 mm through a repeated coating and fluidizing process while spraying a red ginseng extract for spraying on the vacuum-dried red ginseng extract powder having particle sizes of 0.2 to 0.8 mm by a bottom spray method under a fluidized-bed coating condition in a fluidized-bed coater; and then, it sprays and coats a micronized red ginseng powder solution, so that the preparing cost can be reduced through the significant shortening of the fluidized-bed coating time and it has excellent texture and prevention of moisture absorption functions.

### TECHNICAL FIELD

The present invention relates to red ginseng extract granules and a preparing method thereof, and more particularly, to red ginseng extract granules, and a method for preparing the red ginseng extract granules using red ginseng extract powder and fluidized-bed coater, which can shorten a preparing time of the red ginseng extract granules by reducing an existing fluidized-bed coating process through 7 to 8 steps to 3 to 4 steps by using dried red ginseng extract powder and enhance the price competitiveness by significantly increasing the production capacity per hour.

### BACKGROUND ART

There is a circular red ginseng, a red ginseng powder, a red ginseng slice, and a red ginseng extract etc. in red ginseng products, which are marketed currently. Here, the red ginseng extract among these products makes a great appeal to consumers.

However, there are a discomfort for drinking, a managerial difficulty of using container, and a difficulty of a distribution of liquid products in the red ginseng extracts. In order to solve these problems, by using of “Method for making spherical pellet improved powder fluency and storage quality without extender from ginseng concentrates” (Korean patent registration No. 10-0813387, patent literature 1) and “Method for preparing the spherical granules of red ginseng extract concentrates by using micronized red ginseng powder (Korean patent registration No. 10-1357169, patent literature 2), a new ginseng product called as a red ginseng extract granule of 100%, in that the ingredients having the ginseng functions are highly concentrated, so that the daily intake is very small, it is in the form of grains, so that it's easy to carry, and it is well melted in water, so that it is easy to take, has been marketed currently. Accordingly, it expects a farm income through the promotion of domestic consumption and is greatly contributed to the position enhancement of Korean red ginseng through the export increase.

The above patent literatures 1 and 2 can maintain red ginseng ingredients of 100% and provide easy eating and carrying while excluding the addition of foreign objects or other additives.

In addition, in order to enhance the consumer preferences, the manufactured grain takes rounded sphere shapes.

In order to satisfy these conditions, it is manufactured by using a fluidized bed coating machine.

In case of the size of the ginseng extracted pill disclosed in the patent literature 1, the manufactured ginseng extracted pill is 700-5,000 μm in size.

The size of the ginseng extracted grain disclosed in the patent literature 2 is also 700-5,000 μm, which is very small.

Practically, it is desirable to mix the products having the above sizes in a liquid such as water so as to take it.

Where it is eaten in the form of the powder, since the particle size thereof is too small, the ginseng powder is blown in even small wind and comes into the respiratory tract through a nose or a mouth, so that it can cause coughs etc.

Therefore, it is necessary to manufacture the ginseng products having a proper weight capable of easily eating with the spoon in a solid state regardless of wind, unlikely the patent literatures 1 and 2, a proper size of easily eating by hand, and a predetermined particle size capable of being satisfied with the consumer preferences.

However, in order that the liquid is granulated by using the fluidized bed coating machine and then, the particle is coated for the scale-up, it requires more time and facility cost.

Referring to “Fluidized bed granulating coating device and fluidized bed granulation coating method” (Korean patent laying-open gazette No. 10-2003-0007568, patent literature 3) related to the technology on the fluidized bed device, in case of the continuous fluidized bed granulating machine for mass production, since the classification effect is unstable, there is a problem in that the particle size distribution of the discharge products is uneven. Also, in case of the sequencing fluidized bed granulating machine, there is a problem in that the mass production is difficult.

Since the fluidized bed granulating machine commonly used is not a continuous type, in order that the extract granules prepared in the fluidized bed coating machine of the patent literatures 1 and 2 has a predetermined size and has been scaled up above mm units, it requires a great deal of time.

For example, in case of the fluidized bed coating machine using a bottom spray manner and having a production standard of 100 kg, the selling price is about 1 billion won. Here, in order that the initial red ginseng extract is powdered to a fine powder less than 0.2 mm in grain size, it takes about 16 hours. Also, it takes 13 hours for scale-up from the grain size less than 0.2mm to the size of 0.2 to 0.4 m, it takes 12 hours for scale it up the size of 0.4 to 0.6 mm, it takes 11 hours for scale it up the size of 0.6 to 0.8 mm, it takes 10 hours for scale it up the size of 0.8 to 1.0 mm, it takes 9 hours for scale it up the size of 1.0 to 1.20 mm, and it takes 4 hours for scale it up the size more than 1.2 mm.

Moreover, since the manufactured grains are collected in the middle of the processes to be selected, and again go through the spray and fluidized bed coating processes, it takes a long time between each process.

Here, where the moisture coating is conducted in the patent literature 2, it takes an additional 3 hours. Accordingly, when the product of 100 kg is manufactured through the fluidized bed coating machine of about 1 billion won, since it takes at least 78 hours, there is a problem in that the productivity thereof is remarkably deteriorated.

Accordingly, it is still urgent to develop the processes having a sufficient size capable of easily eating final product originating from liquid red ginseng extract with the spoon or the hand, having a good rounded shape in outward appearance, and excluding the excessive increase in the cost of production.

In the conventional manufacturing process of 100% red ginseng extract granules, the red ginseng extract granules of a round shape having an average size of 1.5 mm is manufactured through the fluidized bed coating processes of 7-8 steps from the red ginseng extract by using the fluidized bed coating machine. However, since it takes a long manufacturing time and the optimum capacity of the high priced fluidized bed coating machine is small, it becomes a key factor in prices rise. Accordingly, in order to increase the price competitiveness, it requires a technology development capably of remarkably reducing the manufacturing steps of the fluidized bed coating.

### CITATION LIST

[Patent Literature 1]

Korean Patent Registration No. 10-0813387 (Mar. 6, 2008),

[Patent Literature 2]

Korean Patent Registration No. 10-1357169 (Jan. 23, 2014)

[Patent Literature 3]

Korean Patent Laying-open gazette No. 10-2003-0007568 (Jan. 23, 2003)

### DISCLOSURE

### Technical Problem

Red ginseng extract granules and a method for preparing red ginseng extract granules using red ginseng extract powder and a fluidized-bed coater of the present invention are to solve the problems occurring in the related art. An object of the present invention is to provide a method for preparing red ginseng extract granules with excellent price competitiveness by drying and grinding a red ginseng extract to be amorphously powdered with a smaller size than a final product object and coating the red ginseng extract for spraying on the amorphous powder through fluidizing and spraying process by using a fluidized-bed coater to shorten the fluidized-bed coating preparing process of the red ginseng extract granules, thereby reducing a fluidized-bed coating time of the red ginseng extract granules and increasing an optimal production capacity of the fluidized-bed coater.

Also, the amorphous red ginseng extract powder grinded and selected is formed in a proper size capable of repeating the coating process 2-3 times by using the fluidized bed coating machine, thereby satisfying two goals, which are the process shortening and the maintain of the round shape proper for the consumers preference.

In particular, the drying and the grinding are conducted through a vacuum drying manner and a roll mill grinding manner capable of minimizing the cost increase and having a small denaturation of the pharmacological ingredient, it is grinded in the multi-stage grinding manner of gradually narrowing the gap between the rolls in the roll mill grinding manner, and a hemispherical grooves are formed the surface between two rolls, so that the separater ratio owing to the differences of the particle size can be minimized, and the amorphous red ginseng extract powder grinded is formed in an approximately round shape, so that the red ginseng extract granules of the round shape can be easily manufactured in the following coating processes.

### Technical solution

According to one aspect of the present invention so as to accomplish these objects, there is provided to a method for preparing red ginseng extract granules using red ginseng extract powder and fluidized-bed coater, the method including the steps of: an extract drying step of preparing a dried extract mass by drying an red ginseng extract solution; a grinding step of preparing amorphous red ginseng extract powder by grinding the dried extract mass prepared in the extract drying step; a separating step of separating only particle sizes of 0.2 to 0.8 mm from the amorphous red ginseng extract powder; a spherically coating step of preparing red ginseng extract spherical granules in which particle sizes are larger than those of the amorphous red ginseng extract powder through the last spraying and fluidizing step while the particle sizes are increased for each step by spraying and fluidizing a red ginseng extract for spraying on the separated amorphous red ginseng extract powder in the fluidized-bed coater by a bottom spray method under a fluidized-bed coating condition and repeating the spraying and fluidizing in multistage; and a fluidized-bed coating step for prevention of moisture absorption of preparing red ginseng extract granules with prevention of moisture absorption by spraying and coating a micronized red ginseng powder solution for spraying on the red ginseng extract spherical granules in the fluidized-bed coater by a bottom spray method under a fluidized-bed coating condition.

Here, the extract drying step prepares the dried extract mass through any one of vacuum drying, hot air drying, freeze drying, and ambient air drying.

Also, in the grinding step, the amorphous red ginseng extract powder is prepared by grinding the dried extract mas using a roll-mill grinder.

Also, the fluidized-bed coating condition is an intake air amount of 5 to 15 m³/sec, an injection pipe temperature of 80 to 150° C., spray pressure of 1.0 to 5.0 bar, and a spraying rate of 1 to 10 kg/hr.

Also, the red ginseng extract for spraying has a solid content of 10 to 50 wt % of the entire weight thereof.

Also, the micronized red ginseng powder solution for spaying is prepared by preparing red ginseng powder having particle sizes of 5 to 100 μm by using a micronizer and dissolving the prepared ginseng powder in water.

Also, the coating content of the micronized red ginseng powder solution for spaying is 1 to 10 wt % of the entire weight of the red ginseng extract granules.

According to another aspect of the present invention so as to accomplish these objects, there is provided to a method for preparing red ginseng extract granules using red ginseng extract powder and fluidized-bed coater, the method including the steps of: an extract drying step of preparing a dried extract mass by injecting a red ginseng extract poured in trays into a vacuum drier and then vacuum-drying the red ginseng extract; a grinding step of preparing amorphous red ginseng extract powder by grinding the dried extract mass prepared in the extract drying step by a roll mill grinder; a separating step of separating only particle sizes of 0.6 to 0.8 mm from the amorphous red ginseng extract powder by passing a separator; a spherically coating step constituted by a first spherically coating step of preparing primary granules having particle sizes of 0.8 to 1.0 mm by spraying and fluidizing a red ginseng extract for spraying with a solid content of 10 to 50 wt % on the separated amorphous red ginseng extract powder by a bottom spray method under a fluidized-bed coating condition of an intake air amount of 5 to 15 m³/sec, an injection pipe temperature of 80 to 150° C., spray pressure of 1.0 to 5.0 bar, and a spraying rate of 1 to 10 kg/hr in a fluidized-bed coater, a second spherically coating step of preparing secondary granules having particle sizes of 1.0 to 1.2 mm by performing repetitively fluidizing while spraying the red ginseng extract for spraying with the solid content of 10 to 50 wt % on the primary granules by a bottom spray method under the same fluidized-bed coating condition as the first spherically coating step in the fluidized-bed coater, and a third spherically coating step of preparing red ginseng extract spherical granules having particle sizes of 1.2 to 1.7 mm by performing repetitively fluidizing while spraying the red ginseng extract for spraying with the solid content of 10 to 50 wt % on the secondary granules by a bottom spray method under the same fluidized-bed coating condition as the first spherically coating step in the fluidized-bed coater; and a fluidized-bed coating step for prevention of moisture absorption of preparing red ginseng extract granules with prevention of moisture absorption by spraying and coating a micronized red ginseng powder solution for spraying prepared with micronized red ginseng powder having sizes of 5 to 100 μm on the red ginseng extract spherical granules by a bottom spray method to become 3 wt % of the entire weight of the red ginseng extract granules in the fluidized-bed coater.

Here, in the grinding step, the dried extract mass is injected and grinded between two rolls of the roll mill grinder which is formed movably forward and backward in a facing direction of the two rolls; it is grinded in multiple stages while the distance between the rolls is gradually decreased; and lattice-type embossed patterns are formed on the surfaces of the two rolls respectively and semi-spherical grooves are formed in the lattice-type pattern, so that the dried extract mass is guided and grinded between the semi-spherical grooves when the grinding is performed by approaching the two rolls.

Also, as shown in FIG. 5, a red ginseng extract granule according to the present invention, includes a core portion (30) formed with an amorphous red ginseng extract and having a particle size of 0.6 to 0.8 mm; a red ginseng extract coating portion (40) integrated with the core portion (30) and formed by fluidizing and coating the red ginseng extract for spraying in a multilayer; and a moisture preventing absorption coating portion (50) formed by fluidizing and coating the micronized red ginseng powder solution for spraying on an outside the red ginseng extract coating portion, wherein the red ginseng extract granules have particle sizes of 1.2 to 1.7 mm.

### Advantageous Effects

According to the method for preparing the red ginseng extract granules according to the present invention, as compared with the conventional methods, it is possible to enhance price competitiveness of the red ginseng extract granules product by reducing a fluidized-bed coating preparing process of the red ginseng extract granules to shorten a processing time and increasing the production capacity of the fluidized-bed coater and largely contribute to enhancing the phase of Korean red ginseng according to an increase in farm income through the promotion of domestic consumption of red ginseng and an increase in exports.

### BRIEF DESCRIPTION OF DRAWINGS

The above and other objects, features and advantages of the present invention will be more apparent from the following detailed description taken in conjunction with the accompanying drawings, in which:

FIG. 1 is a photograph illustrating a dried extract mass before dried in a vacuum drier according to the present invention;

FIG. 2 is a photograph illustrating a sample obtained by a manufacturing process according to a comparative example 3 of a conventional art explained in a description of the present invention;

FIG. 3 is a photograph illustrating a sample obtained by a manufacturing process according to an example 3 of the present invention;

FIG. 4 is a photograph illustrating a construction of a roll mill grinder used in a grinding step according to the present invention;

FIG. 5 is a conceptual sectional view illustrating a structure of a red ginseng extract granule according to an example 3 of the present invention; and

FIG. 6 is a photograph of enlarging a red ginseng extract granule prepared according to the present invention.

### REFERENCE SIGNS LIST

10: lattice-type embossed patterns

20: semi-spherical grooves

30: core portion

40: red ginseng extract coating portion

50: moisture preventing absorption coating portion

### BEST MODE

### Mode for Invention

Hereinafter, red ginseng extract granules, and a method for preparing the red ginseng extract granules using red ginseng extract powder and a fluidized-bed coater according to the invention will be described in detail with reference to the accompanying drawings and pictures.

A method for preparing red ginseng extract granules using red ginseng extract powder and a fluidized-bed coater is constituted by an extract drying step, a grinding step, a separating step, a spherically coating step, and a fluidized-bed coating step for preventing moisture absorption.

1. Extract Drying Step

A dried extract mass is prepared by drying a red ginseng extract.

A drying method may be selectively performed by any one of vacuum drying, hot air drying, freeze drying, and ambient air drying.

Among them, preferably, a vacuum drying method is suitable.

In the vacuum drying method, a drying device constituted by trays in which the red ginseng extract is accommodated and a vacuum drier in which the trays are accommodated with a multilayer may be used.

In the vacuum drying method, there is an advantage in that the loss of active compounds is low compared with the hot air drying method and a drying time is short compared with the ambient air drying method.

Alternatively, there is an advantage in that the drying cost is low compared with the freeze drying method.

2. Grinding Step

Amorphous red ginseng extract powder is prepared by grinding the dried extract mass prepared in the extract drying step.

In this case, as the grinding device, various known grinding devices may be used, but preferably, the dried extract mass may be grinded by using a roll-mill grinder in which two rolls are disposed in parallel with each other.

More particularly, the dried extract mass is injected and grinded between two rolls of the roll mill grinder which is formed movably forward and backward in a facing direction of the two rolls.

In this case, in an initial stage, the dried extract mass is grinded into small chunks by setting a dried extract mass solidified in a tray shape to an interval enough to be grinded into large chunks. Next, while the distance between the rolls is gradually decreased, the dried extract mass is gradually grinded into the small chunks and finally grinded so that the distance between the rolls is about 0.2 to 0.8 mm.

As such, grinding in multiple stages is to maximize a recovery rate of the red ginseng extract powder in a subsequent separating step by preventing the dried extract mass from being grinded into too small chunks.

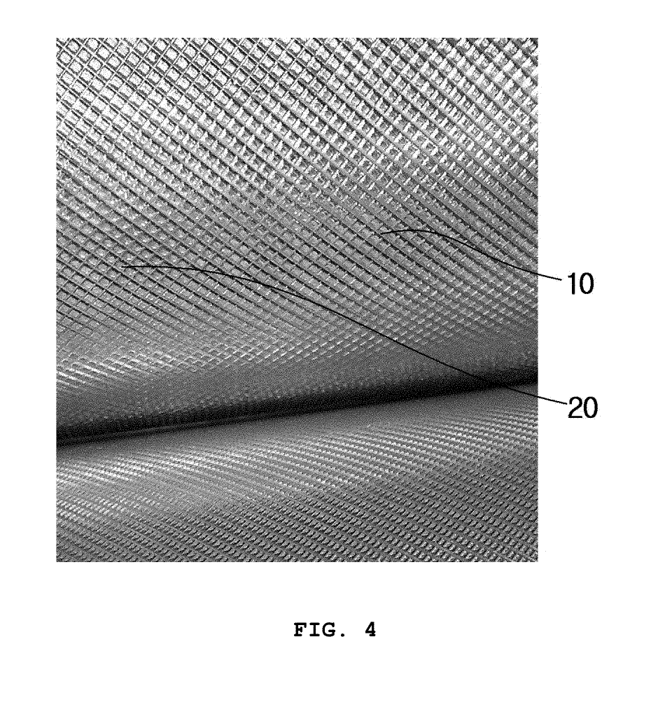

Particularly, on the surfaces of the two rolls, as illustrated in FIG. 4, lattice-type embossed patterns 10 are formed, respectively, and semi-spherical grooves 20 are formed in the lattice-type pattern 10. When the grinding is performed by approaching the two rolls, the dried extract mass may be guided and grinded between the semi-spherical grooves, preferably.

3. Separating Step

Only particles having a size of 0.2 to 0.8 mm are separated from the amorphous red ginseng extract powder.

The separating may be performed by a separator such as a known net-shaped sieve or easily performed by installing a vibrating net sieve at an outlet of the roll mill grinder.

When the particle size is less than 0.2 mm, compared with red ginseng extract granules prepared by an existing preparing method, there is no large difference in preparing cost and thus the effectiveness is deteriorated. On the contrary, when the particle size is greater than 0.8 mm, it is difficult to prepare the red ginseng extract spherical granules and thus product quality in external appearance is deteriorated.

Accordingly, in order to prepare the red ginseng extract granules having price competitiveness and excellent texture and prevention of moisture absorption functions, the separated size is preferably in a range of 0.2 to 0.8 mm.

In this case, the separated particle size is most preferably 0.6 to 0.8 mm.

4. Spherically Coating Step

After the separated amorphous red ginseng extract powder is injected in a fluidized-bed coater, a red ginseng extract for spraying is sprayed and fluidized by a bottom spray method under a fluidized-bed coating condition. While the particle sizes are increased in stages by repeating spraying and fluidizing in multistage, the red ginseng extract granules having spherical particle shapes are prepared through the final spraying and fluidizing step.

An average particle size of the red ginseng extract spherical granules is preferably 1.5 mm, but is not limited thereto and may be in a range of about 1.2 to 1.7 mm.

In this case, the fluidized-bed coating condition may preferably include an intake air amount of 5 to 15 m³/sec, an injection pipe temperature (intake air temperature) of 80 to 150° C., spray pressure of 1.0 to 5.0 bar, and a spraying rate of 1 to 10 kg/hr, but is not limited thereto.

Most preferably, the intake air amount is 10 m³/sec, the injection pipe temperature is 90° C., the spray pressure is 2.5 bar, and the spraying rate is 5 kg/hr.

Alternatively, in the red ginseng extract for spraying, the solid content may be 10 to 50 wt % with respect to the entire weight of the red ginseng extract for spraying.

The spherically coating step may preferably be constituted by a first spherically coating step, a second spherically coating step, and a third spherically coating step to be described below which are suitable in the case where the particle size separated in the separating step is 0.6 to 0.8 mm.

In the first spherically coating step, in the amorphous red ginseng extract powder having particle sizes of 0.6 to 0.8 mm separated in the fluidized-bed coater, the red ginseng extract for spraying with the solid content of 10 to 50 wt % is sprayed by a bottom spray method under a fluidized-bed coating condition of an intake air amount of 5 to 15 m³/sec, an injection pipe temperature of 80 to 150° C., spray pressure of 1.0 to 5.0 bar, and a spraying rate of 1 to 10 kg/hr and fluidized to prepare primary granules having particle sizes of 0.8 to 1.0 mm.

Further, in the second spherically coating step, in the primary granules in the fluidized-bed coater, the red ginseng extract for spraying having the solid content of 10 to 50 wt % is sprayed by the bottom spray method under the same fluidized-bed coating condition as the first spherically coating step and repetitively fluidized to prepare secondary granules having particle sizes of 1.0 to 1.2 mm.

Further, in the third spherically coating step, in the secondary granules in the fluidized-bed coater, the red ginseng extract for spraying having the solid content of 10 to 50 wt % is sprayed by the bottom spray method under the same fluidized-bed coating condition as the first spherically coating step and repetitively fluidized to prepare red ginseng extract spherical granules having particle sizes of 1.2 to 1.7 mm.

The spherically coating step may be repetitively performed by adding a spherically coating step when the particle size is 0.2 mm or greater and less than 0.6 mm in the separating step.

5. Fluidized-Bed Coating Step for Prevention of Moisture Absorption

In the fluidized-bed coater, a micronized red ginseng powder solution for spaying are sprayed and coated on the red ginseng extract spherical granules having the sizes of 1.2 to 1.7 mm by a bottom spray method under a fluidized-bed coating condition to prepare the red ginseng extract granules with prevention of moisture absorption.

In this case, the micronized red ginseng powder solution for spaying may be prepared by preparing red ginseng powder having particle sizes of 5 to 100 μm by using a micronizer and dissolving the prepared ginseng powder in water.

More preferably, the particle size may be limited to 10 to 30 μm.

Alternatively, the coating content of the micronized red ginseng powder solution for spaying is preferably 1 to 10 wt % of the entire weight of the red ginseng extract granules.

In this case, the optimal weight may be 2 to 4 wt %.

In this case, the fluidized-bed coating condition may be the same condition as the spherically coating step described above.

That is, the spherically coating step may be performed under the fluidized-bed coating condition of an intake air amount of 5 to 15 m³/sec, an injection pipe temperature of 80 to 150° C., spray pressure of 1.0 to 5.0 bar, and a spraying rate of 1 to 10 kg/hr.

As an optimal condition, the intake air amount may be 13 m³/sec, the injection pipe temperature may be 80° C., the spray pressure may be 2.0 bar, and the spraying rate may be 6 kg/hr.

The fluidized-bed coating step for prevention of moisture absorption serves to enhance a prevention of moisture absorption function by using the micronized red ginseng powder solution as disclosed in Patent Document 2.

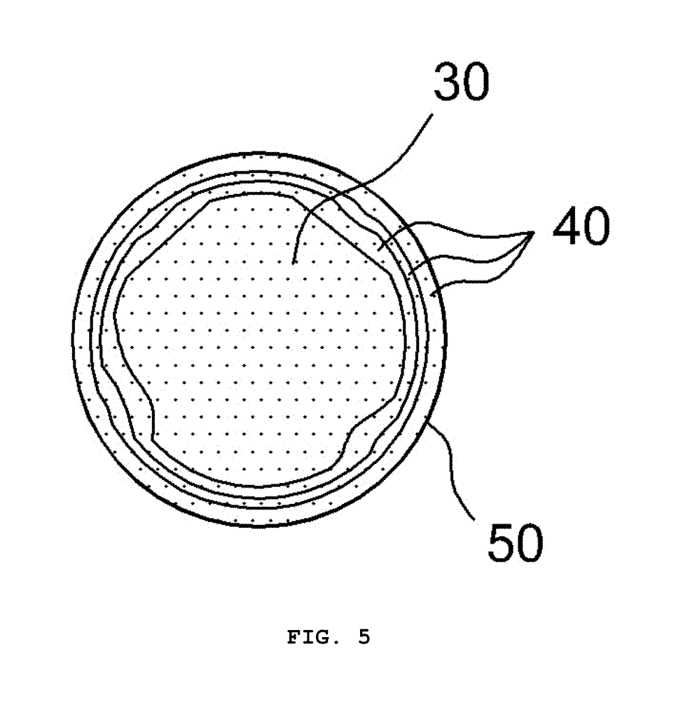

The red ginseng extract granule of the present invention prepared by the above process, as illustrated in FIG. 5, is constituted by a core portion 30, a red ginseng extract coating portion 40, and a moisture preventing absorption coating portion 50.

The core portion 30 is formed with the amorphous red ginseng extract powder by grinding and separating through the roll mill grinder and has a particle size of 0.6 to 0.8 mm.

Further, the red ginseng extract coating portion 40 is integrated with the core portion 30 outside the core portion 30 and formed by fluidizing and coating the red ginseng extract for spraying in a multilayer depending on the number of repetition times of the fluidized-bed coating.

Further, the moisture preventing absorption coating portion 50 is formed by fluidizing and coating the micronized red ginseng powder solution for spraying on the outside the red ginseng extract coating portion.

The formed red ginseng extract granules have particle sizes of 1.2 to 1.7 mm enough to be easily taken with a hand or a spoon.

Hereinafter, the present invention will be described in detail through Examples, but the following Examples and Experimental Examples just exemplify one aspect of the present invention, and the scope of the present invention is not limited by the following Examples and Experimental Examples.

### EXAMPLE 1

1. Preparation of Red Ginseng Extract Powder

A plurality of trays having horizontal and vertical sizes of 50 cm and a height of 5 cm was prepared, a red ginseng extract was poured in each tray, trays were input in a multilayer in a vacuum drier, and then the red ginseng extract was dried by applying vacuum to the vacuum drier at a temperature of 40° C. to prepare a dried extract mass.

Next, the dried extract mass was grinded into chunks of 20 cm³ by using a hammer and then injected the chunks into the roll mill grinder.

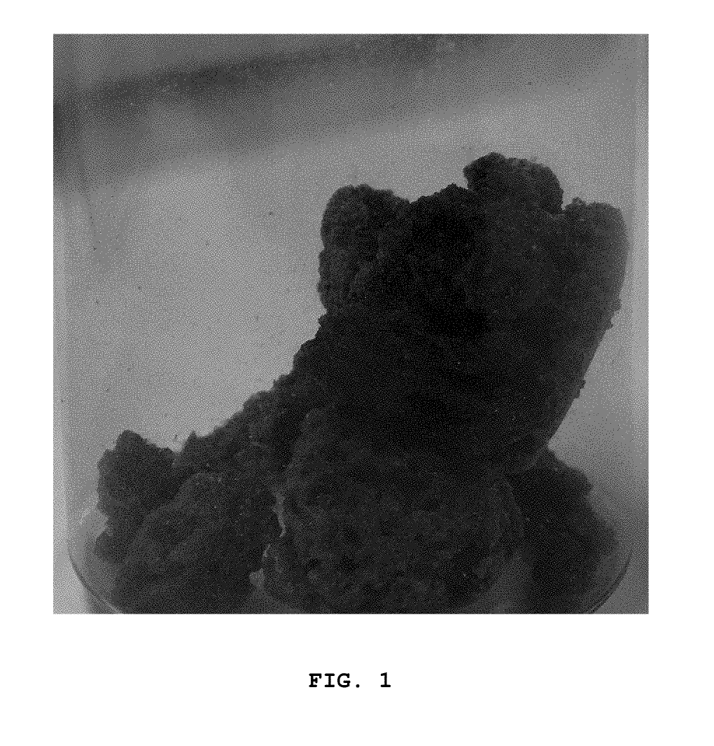

FIG. 1 is a photograph illustrating a part of the dried extract mass before being injected into the roll mill grinder.

As illustrated in the drawing, the dried extract mass had an amorphous chuck shape.

The roll mill grinder was used, in which a distance between two roll disposed in parallel with each other can be adjusted and a lattice-shaped pattern is embossed on the surface of the roll.

In an initial stage, the amorphous red ginseng extract powder was prepared to have a distance between the two rolls of 2.5 cm, subsequently 1 cm, 5 mm, 1 mm, and 0.4 mm.

Only particles having the size of 0.2 to 0.4 mm in the amorphous red ginseng extract powder were separated by the separator and prepared.

2. Preparation of Red Ginseng Extract Granules

The amorphous red ginseng extract powder having the particle size of 0.2 to 0.4 mm was injected and fluidized in the fluidized-bed coater having an available weight of 100 kg. Under the fluidized-bed coating condition of an intake air amount of 10 m³/sec, an injection pipe temperature of 90° C., spray pressure of 2.3 bar, and a spraying rate of 7 kg/hr, while the red ginseng extract for spraying of which the solid content was adjusted to 40 wt % was sprayed by a bottom spray method, 100% pure red ginseng extract granules having particle sizes of 1.2 to 1.7 mm and spherical shapes were prepared through a repeated coating and fluidizing process.

More particularly, first, granules having particle sizes of 0.4 to 0.6 mm were formed through the spraying and fluidizing process for 12 hours in the fluidized-bed coater. Second, while the red ginseng extract for spraying was sprayed in the fluidized-bed coater for 11 hours under the same fluidized-bed coating condition, the granules having particle sizes of 0.6 to 0.8 mm were formed through the spraying and fluidizing process for 11 hours. Third, the granules having particle sizes of 0.8 to 1.0 mm were formed through the same process for 10 hours. Fourth, the granules having particle sizes of 1.0 to 1.2 mm were formed through the same process for 9 hours. Fifth, the red ginseng extract spherical granules having particle sizes of 1.2 to 1.7 mm were formed through the same process for 4 hours.

3. Preparation of Red Ginseng Extract Granules with Prevention of Moisture Absorption

After the red ginseng extract spherical granules having the particle size of 1.2 to 1.7 mm were injected and fluidized in the fluidized-bed coater. Under the fluidized-bed coating condition of an intake air amount of 13 m³/sec, an injection pipe temperature of 80° C., spray pressure of 2.0 bar, and a spraying rate of 6 kg/hr, while a micronized red ginseng powder solution for spraying in which a micronized red ginseng powder grinded with a size of 15 to 25 μm was dissolved in water was sprayed by a bottom spray method to be 3% of the entire weight of the red ginseng extract granules, red ginseng extract granules with prevention of moisture absorption were prepared through the coating and fluidizing process.

The red ginseng extract granules were coated with a small amount of micronized red ginseng extract solution and had no change in identified particle size.

### EXAMPLE 2

1. Preparation of Red Ginseng Extract Powder

The preparation of the red ginseng extract powder was performed in the same manner as Example 1, and finally, in the grinding process, a distance between two rolls was 0.6 mm and only particles of 0.4 to 0.6 mm were separated by the separator to prepare the amorphous red ginseng extract powder.

2. Preparation of Red Ginseng Extract Granules

The preparation of red ginseng extract granules was performed in the same manner as Example 1, but repetitively performed in four stages unlike Example 1.

Particularly, in the first spherically coating step, the amorphous red ginseng extract powder of 0.4 to 0.6 mm was sprayed and fluidized with the red ginseng extract solution for spraying by a bottom spray method for 11 hours in the same method as Example 1 to form primary granules having particle sizes of 0.6 to 0.8 mm. In the second spherically coating step, the red ginseng extract solution for spraying was sprayed and fluidized on the primary granules by a bottom spray method for 10 hours in the same manner to form secondary granules having particle sizes of 0.8 to 1.0 mm. In the third spherically coating step, the red ginseng extract solution for spraying was sprayed for 9 hours to form tertiary granules having particle sizes of 1.0 to 1.2 mm. In the fourth spherically coating step, the red ginseng extract solution for spraying was sprayed for 4 hours to form red ginseng extract spherical granules having particle sizes of 1.2 to 1.7 mm.

3. Preparation of Red Ginseng Extract Granules with Prevention of Moisture Absorption

The red ginseng extract spherical granules having particle sizes of 1.2 to 1.7 mm were fluidized and coated in the same manner as the step 3 of Example 1 to prepare the red ginseng extract granules with prevention of moisture absorption.

### EXAMPLE 3

1. Preparation of Red Ginseng Extract Powder

The preparation of the red ginseng extract powder was performed in the same manner as Example 1, and finally, in the grinding process, a distance between two rolls was 0.8 mm and only particles of 0.6 to 0.8 mm were separated by the separator to prepare the amorphous red ginseng extract powder.

2. Preparation of Red Ginseng Extract Granules

The preparation of red ginseng extract granules was preformed in the same manner as Example 1 and the coating step was performed by three steps of the first spherically coating step, the second spherically coating step, and the third spherically coating step.

Particularly, in the first spherically coating step, the amorphous red ginseng extract powder of particle sizes of 0.6 to 0.8 mm was injected in the fluidized-bed coater and sprayed and fluidized with the red ginseng extract solution for spraying by a bottom spray method for 10 hours under the same fluidized-bed coating condition as Example 1 to prepare primary granules having particle sizes of 0.8 to 1.0 mm. In the second spherically coating step, the red ginseng extract solution for spraying was sprayed and fluidized on the primary granules for 9 hours in the same manner as the first spherically coating step to prepare secondary granules having particle sizes of 1.0 to 1.2 mm. In the third spherically coating step, the red ginseng extract solution for spraying was sprayed and fluidized on the secondary granules for 4 hours in the same manner as the first spherically coating step to form red ginseng extract spherical granules having particle sizes of 1.2 to 1.7 mm.

3. Preparation of Red Ginseng Extract Granules with Prevention of Moisture Absorption

The red ginseng extract spherical granules having particle sizes of 1.2 to 1.7 mm were fluidized and coated in the same manner as the step 3 of Example 1 to prepare the red ginseng extract granules with prevention of moisture absorption.

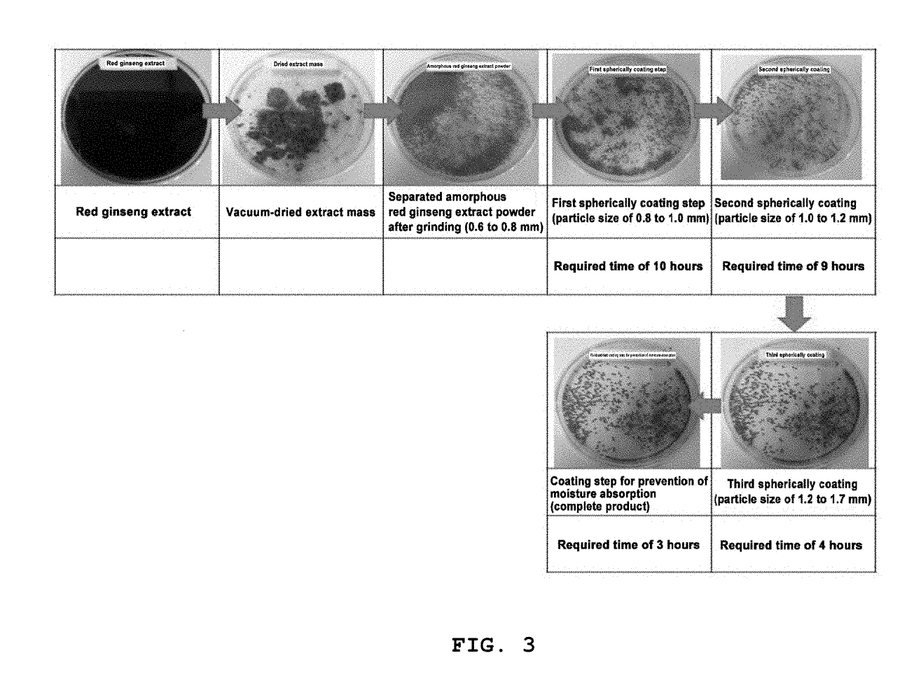

FIG. 3 illustrates a particle size and a required time for each fluidized-bed coating step prepared by the process.

### EXAMPLE 4

1. Preparation of Red Ginseng Extract Powder

The preparation of red ginseng extract powder was performed in the same manner as Example 1 and the roll mill grinder in which semi-spherical grooves were formed at the center of the a lattice-shaped embossed pattern on the roll surface was used.

Further, finally, in the grinding process, a distance between two rolls was 0.8 mm and only particles of 0.6 to 0.8 mm were separated by the separator to prepare the amorphous red ginseng extract powder.

FIG. 4 is a photograph of amorphous red ginseng extract powder grinded and separated in the roll mill grinder in which the semi-spherical grooves were formed at the pattern on the roll surface.

As illustrated in FIG. 4, the semi-spherical grooves were formed and thus the coating process in the spherical shape was facilitated by taking the entire round shape in spite of the amorphous shape.

2. Preparation of Red Ginseng Extract Granules

In the same manner as Example 3, the fluidizing and coating process was performed by three steps of the first spherically coating step, the second spherically coating step, and the third spherically coating step to form red ginseng extract spherical granules having particle sizes of 1.2 to 1.7 mm.

3. Preparation of Red Ginseng Extract Granules with Prevention of Moisture Absorption

The red ginseng extract spherical granules having particle sizes of 1.2 to 1.7 mm were fluidized and coated in the same manner as the step 3 of Example 1 to prepare the red ginseng extract granules with prevention of moisture absorption.

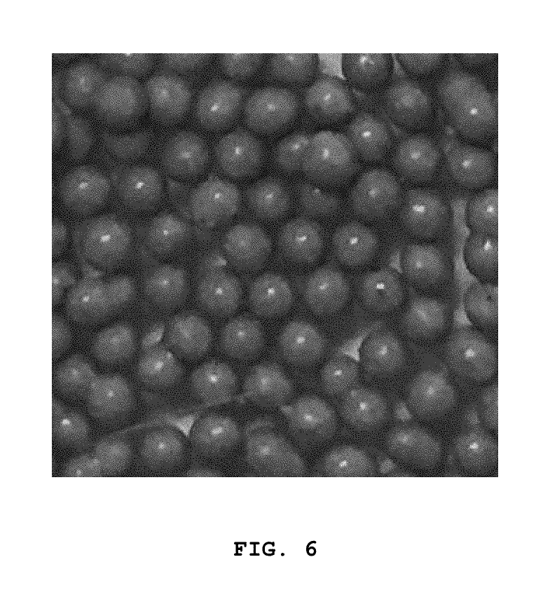

The prepared red ginseng extract granules had spherical shapes as illustrated in FIG. 6.

### COMPARATIVE EXAMPLE 1

1. Preparation of Red Ginseng Extract Powder

The preparation of red ginseng extract powder was performed in the same manner as Example 1, and the amorphous red ginseng extract powder having particle sizes of 0.2 mm or less was separated and prepared by adjusting the distance between the rolls.

2. Preparation of Red Ginseng Extract Granules

The preparation of red ginseng extract granules was performed in the same manner as Example 1, and in an initial stage, in order to form particles of 0.2 mm or less as granules having sizes of 0.2 to 0.4 mm, the red ginseng extract for spraying was additionally sprayed and fluidized by a bottom spray method for 13 hours to finally prepare the red ginseng extract spherical granules having particle sizes of 1.2 to 1.7 mm.

3. Preparation of Red Ginseng Extract Granules with Prevention of Moisture Absorption

The red ginseng extract spherical granules having particle sizes of 1.2 to 1.7 mm were fluidized and coated in the same manner as the step 3 of Example 1 to prepare the red ginseng extract granules with prevention of moisture absorption.

### COMPARATIVE EXAMPLE 2

1. Preparation of Red Ginseng Extract Powder

The preparation of red ginseng extract powder was performed in the same manner as Example 1, and the amorphous red ginseng extract powder having particle sizes of 0.8 to 1.0 mm was separated and prepared by adjusting the distance between the rolls.

2. Preparation of Red Ginseng Extract Granules

The preparation of red ginseng extract granules was performed in the same manner as Example 1, and in an initial stage, while particles having sizes of 0.8 to 1.0 mm were injected into the fluidized-bed coater and fluidized, the red ginseng extract for spraying was sprayed and fluidized for 9 hours by a bottom spray method to prepare granules having particle sizes of 1.0 to 1.2 mm. Second, the red ginseng extract for spraying was sprayed and fluidized for 4 hours additionally to prepare red ginseng extract granules having particle sizes of 1.2 to 1.7 mm.

3. Preparation of Red Ginseng Extract Granules with Prevention of Moisture Absorption

The red ginseng extract granules having particle sizes of 1.2 to 1.7 mm were fluidized and coated in the same manner as the step 3 of Example 1 to prepare the red ginseng extract granules with prevention of moisture absorption.

### COMPARATIVE EXAMPLE 3

1. Preparation of Red Ginseng Extract for Spraying

Water was added in the red ginseng extract having the solid content of 60 wt % and then stirred to prepare the red ginseng extract for spraying having the solid content of 40 wt %.

2. Preparation of Red Ginseng Extract Granules

Under the fluidized-bed coating condition of an intake air amount of 10 m³/sec, an injection pipe temperature of 90° C., spray pressure of 2.3 bar, and a spraying rate of 7 kg/hr, while the red ginseng extract for spraying was sprayed by a bottom spray method, 100% pure red ginseng extract spherical granules having particle sizes of 1.2 to 1.7 mm were prepared through the repeated coating and fluidizing process.

In this case, first, spraying and fluidizing were performed for 16 hours to form primary granules having 0.2 mm or less, second, the primary granules were sprayed and fluidized for 13 hours to form granules of 0.2 to 0.4 mm, and third, fourth, fifth, and sixth, the spraying and fluidizing were performed for 12 hours, 11 hours, 10 hours, and 9 hours, respectively, to be scaled-up with the size of 2 mm for each step.

Further, in seventh step, the spraying and fluidizing were performed for 4 hours to prepare 100% pure red ginseng extract granules having sizes of 1.2 to 1.7 mm and spherical shapes.

3. Preparation of Red Ginseng Extract Granules with Prevention of Moisture Absorption

The red ginseng extract granules having particle sizes of 1.2 to 1.7 mm were fluidized and coated in the same manner as the step 3 of Example 1 to prepare the red ginseng extract granules with prevention of moisture absorption.

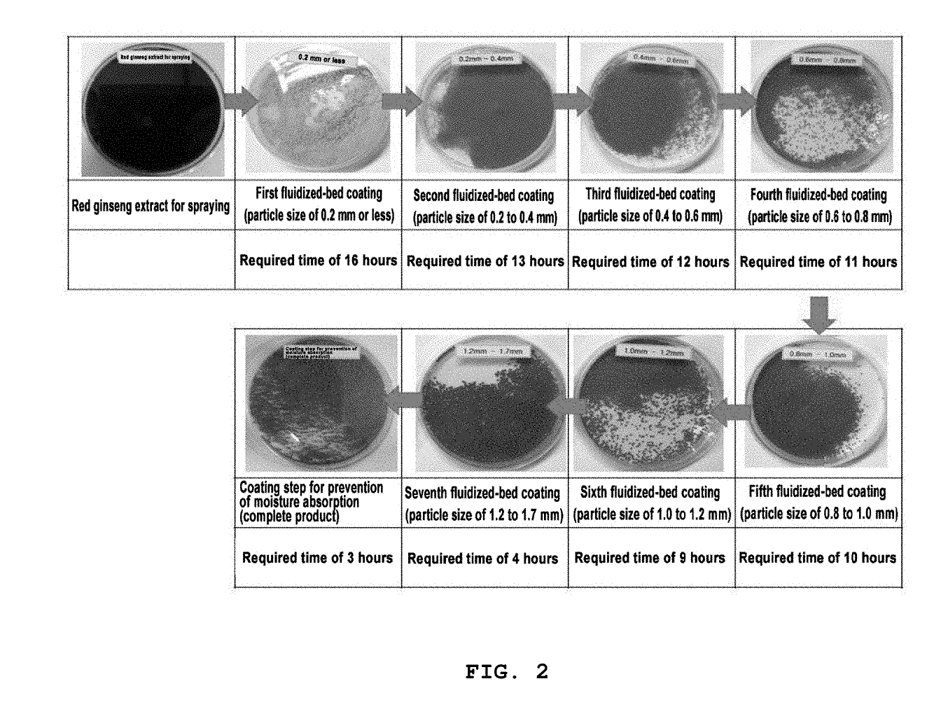

FIG. 2 illustrates a photograph of granules prepared in each step of the existing preparing method and a time thereof.

### EXPERIMENTAL EXAMPLE 1

### Evaluation of Texture and Uniformity of Spherical Appearance of Red Ginseng Extract Granules

In evaluation of texture and uniformity of a spherical appearance, 8 evaluation persons were selected as a descriptive analysis personnel and conducted training for the melting degree in the mouth and uniformity of spherical appearance four times by 30 minutes, and performed objective evaluation by comparing the intensity for each term with the score of the standard product.

The texture was evaluated by the melting degree in the mouth when 0.3 g of the red ginseng extract granule was put and melted in the mouth and swallowed, and the melting degree in the mouth showed the strength felt when the melting degree when 1 g of cotton candy was put was set to 9 point.

Further, the evaluation of the uniformity of the spherical appearance illustrated the shown degree of the red ginseng extract granules when the spherical degree and the uniformity degree of 2 mm glass beads were set to 9 point.

In this case, a 9-point scaling method was used, and it was evaluated that one point was quite mild, 5 point was the middle degree, and 9 point was the very strong degree, and the evaluated result was shown as an average by collecting the results of 8 persons and the result thereof is as the following Table 1.

TABLE 1

| | | Uniformity of |
|---|---|---|
| | Texture | spherical appearance |
| Example 1 | 5.3 | 7.6 |
| Example 2 | 5.2 | 7.3 |
| Example 3 | 5.2 | 7.4 |
| Example 4 | 5.1 | 7.5 |
| Comparative | 5.4 | 7.7 |
| Example 1 | | |
| Comparative | 5.1 | 5.4 |
| Example 2 | | |
| Comparative | 5.5 | 7.5 |
| Example 3 | | |

As seen in Table 1, it could be seen that the red ginseng extract granules prepared by the preparing methods of Examples 1 to 4 had an approximately equal level in the texture and the uniformity of spherical appearance compared with Comparative Example 3 prepared by the existing preparing method.

However, in the case of Comparative Example 2 using the red ginseng extract powder grinded with particle sizes of 0.8 to 1.0 mm, the uniformity of spherical appearance was significantly deteriorated and the productivity was a problem.

### EXPERIMENTAL EXAMPLE 2

### Fluidized-Bed Coating Time

A time required to prepare 100 kg of red ginseng extract granules having particle sizes of 1.2 to 1.7 mm with prevention of moisture absorption by using a fluidized-bed coater of 100 kg production capacity was measured for each preparation condition and the result was as listed in Table 2.

TABLE 2

| | Fluidized-bed coating |
|---|---|
| | time (hr) |
| Example 1 | 49 |
| Example 2 | 37 |
| Example 3 | 26 |
| Example 4 | 26 |
| Comparative Example 1 | 62 |
| Comparative Example 2 | 16 |
| Comparative Example 3 | 78 |

As seen in Table 2, in the case of Examples 1 to 4 using the amorphous red ginseng extract powder having particle sizes of 0.2 to 0.8 mm, the fluidized-bed coating time was significantly shortened and the preparing cost was reduced as compared with the preparing process of Comparative Example 3 prepared by the existing preparing method.

However, when the process of Comparative Example 1 was compared with the existing process of Comparative Example 3, it was determined that even through the preparing time was shortened, the economic effect was slight by considering additional preparing cost of the dried powder of the red ginseng extract and the like.

Meanwhile, it was determined that the short preparing time of Comparative Example 2 had no large meaning because the productivity according to deterioration of uniformity of appearance was decreased as illustrated in the result of Experimental Example 1 described above.

However, in the case of Examples 3 and 4 having an approximately equal level in the texture and the uniformity of spherical appearance, the preparing time at 1/3 level of Comparative Example 3 which was the existing process has a particularly large effect.

### INDUSTRIAL APPLICABILITY

The red ginseng extract granules of the present invention can be singly absorbed in a grain state, it can be absorbed by mixing with other granules, or it can be absorbed by dissolving in water or drinking etc.

What is claimed is:

1. A method for preparing red ginseng extract granules using red ginseng extract powder and fluidized-bed coater, the method comprising the steps of:
an extract drying step of preparing a dried extract mass by drying an red ginseng extract solution;
a grinding step of preparing amorphous red ginseng extract powder by grinding the dried extract mass prepared in the extract drying step;
a separating step of separating only particle sizes of 0.2 to 0.8 mm from the amorphous red ginseng extract powder;
a spherically coating step of preparing red ginseng extract spherical granules in which particle sizes are larger than those of the amorphous red ginseng extract powder through the last spraying and fluidizing step while the particle sizes are increased for each step by spraying and fluidizing a red ginseng extract for spraying on the separated amorphous red ginseng extract powder in the fluidized-bed coater by a bottom spray method under a fluidized-bed coating condition and repeating the spraying and fluidizing in multistage; and
a fluidized-bed coating step for prevention of moisture absorption of preparing red ginseng extract granules with prevention of moisture absorption by spraying and coating a micronized red ginseng powder solution for spraying on the red ginseng extract spherical granules in the fluidized-bed coater by a bottom spray method under a fluidized-bed coating condition.

2. The method for preparing red ginseng extract granules using red ginseng extract powder and fluidized-bed coater as claimed in claim 1, wherein the extract drying step prepares the dried extract mass through any one of vacuum drying, hot air drying, freeze drying, and ambient air drying.

3. The method for preparing red ginseng extract granules using red ginseng extract powder and fluidized-bed coater as claimed in claim 1, wherein, in the grinding step, the amorphous red ginseng extract powder is prepared by grinding the dried extract mas using a roll-mill grinder.

4. The method for preparing red ginseng extract granules using red ginseng extract powder and fluidized-bed coater as claimed in claim 1, wherein the fluidized-bed coating condition is an intake air amount of 5 to 15 m³/sec, an injection pipe temperature of 80 to 150° C., spray pressure of 1.0 to 5.0 bar, and a spraying rate of 1 to 10 kg/hr.

5. The method for preparing red ginseng extract granules using red ginseng extract powder and fluidized-bed coater as claimed in claim 1, wherein the red ginseng extract for spraying has a solid content of 10 to 50 wt % of the entire weight thereof.

6. The method for preparing red ginseng extract granules using red ginseng extract powder and fluidized-bed coater as claimed in claim 1, wherein the micronized red ginseng powder solution for spaying is prepared by preparing red ginseng powder having particle sizes of 5 to 100 μm by using a micronizer and dissolving the prepared ginseng powder in water.

7. The method for preparing red ginseng extract granules using red ginseng extract powder and fluidized-bed coater as claimed in claim 1, wherein the coating content of the micronized red ginseng powder solution for spaying is 1 to 10 wt % of the entire weight of the red ginseng extract granules.

8. A method for preparing red ginseng extract granules using red ginseng extract powder and fluidized-bed coater, the method comprising the steps of:
an extract drying step of preparing a dried extract mass by injecting a red ginseng extract poured in trays into a vacuum drier and then vacuum-drying the red ginseng extract;
a grinding step of preparing amorphous red ginseng extract powder by grinding the dried extract mass prepared in the extract drying step by a roll mill grinder;
a separating step of separating only particle sizes of 0.6 to 0.8 mm from the amorphous red ginseng extract powder by passing a separator;
a spherically coating step constituted by a first spherically coating step of preparing primary granules having particle sizes of 0.8 to 1.0 mm by spraying and fluidizing a red ginseng extract for spraying with a solid content of 10 to 50 wt % on the separated amorphous red ginseng extract powder by a bottom spray method under a fluidized-bed coating condition of an intake air amount of 5 to 15 m³/sec, an injection pipe temperature of 80 to 150° C., spray pressure of 1.0 to 5.0 bar, and a spraying rate of 1 to 10 kg/hr in a fluidized-bed coater, a second spherically coating step of preparing secondary granules having particle sizes of 1.0 to 1.2 mm by performing repetitively fluidizing while spraying the red ginseng extract for spraying with the solid content of 10 to 50 wt % on the primary granules by a bottom spray method under the same fluidized-bed coating condition as the first spherically coating step in the fluidized-bed coater, and a third spherically coating step of preparing red ginseng extract spherical granules having particle sizes of 1.2 to 1.7 mm by performing repetitively fluidizing while spraying the red ginseng extract for spraying with the solid content of 10 to 50 wt % on the secondary granules by a bottom spray method under the same fluidized-bed coating condition as the first spherically coating step in the fluidized-bed coater; and
a fluidized-bed coating step for prevention of moisture absorption of preparing red ginseng extract granules with prevention of moisture absorption by spraying and coating a micronized red ginseng powder solution for spraying prepared with micronized red ginseng powder having sizes of 5 to 100 μm on the red ginseng extract spherical granules by a bottom spray method to become 3 wt % of the entire weight of the red ginseng extract granules in the fluidized-bed coater.

9. The method for preparing red ginseng extract granules using red ginseng extract powder and fluidized-bed coater as claimed in claim 8, wherein, in the grinding step, the dried extract mass is injected and grinded between two rolls of the roll mill grinder which is formed movably forward and backward in a facing direction of the two rolls; it is grinded in multiple stages while the distance between the rolls is gradually decreased; and lattice-type embossed patterns are formed on the surfaces of the two rolls respectively and semi-spherical grooves are formed in the lattice-type pattern, so that the dried extract mass is guided and grinded between the semi-spherical grooves when the grinding is performed by approaching the two rolls.

10. A red ginseng extract granule, comprising:
a core portion (30) formed with an amorphous red ginseng extract and having a particle size of 0.6 to 0.8 mm;
a red ginseng extract coating portion (40) integrated with the core portion (30) and formed by fluidizing and coating the red ginseng extract for spraying in a multilayer; and
a moisture preventing absorption coating portion (50) formed by fluidizing and coating the micronized red ginseng powder solution for spraying on an outside the red ginseng extract coating portion, wherein the red ginseng extract granules have particle sizes of 1.2 to 1.7 mm.
